(19) United States
(12) Patent Application Publication
(10) Pub. No.: US 2009/0133543 A1
(43) Pub. Date: May 28, 2009

(54) COMBINATION TOOL

(75) Inventors: Franz DIEHL, Saulheim (DE); Michael Schumacher, Bingen (DE); Gerhard Kohler, Bischofsheim (DE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/277,610

(22) Filed: Nov. 25, 2008

(30) Foreign Application Priority Data
Nov. 26, 2007 (DE) 102007056850.0

(51) Int. Cl. B25B 23/00

(52) U.S. Cl. 81/461

(57) ABSTRACT

A combination tool is provided that includes, but is not limited to a tool shaft with an inner part and an outer part, a first tool head that is integrally formed on the inner part and a differently designed second tool head that is integrally formed on the outer part. The tool shaft is realized in such a way that it can be inserted into a machine and features at least one holding element for mounting a tool head thereon in a locking fashion.

### CROSS-REFERENCE TO RELATED APPLICATION

This application claims priority to German Patent Application No. 102007056850.0, filed Nov. 26, 2007, which is incorporated herein by reference in its entirety.

### TECHNICAL FIELD

The invention pertains to a tool and more specifically to a combination tool.

### BACKGROUND

Hand screw drivers in the form of a combination tool that can be used as a screw driver and as a socket wrench are known, for example, from German publication reference DE 2 117 797. This publication describes a hand tool that not only features a screw driver point, but also a socket wrench slot that is non-positively connected thereto, and the respective hand tool end to be used can be selected by means of an axial displacement against the force of a flat coil spring arranged on the screw driver shaft.

This known combination of differently dimensioned functional ends on a hand tool is already confined in that it does not combine two functional ends for a machine-compatible tool. In the present hand tool, an end such as, for example, a Phillips screw driver end or a slotted screw driver end or an externally gripping functional end such as, for example, a polygonal socket wrench end can only be selected and used manually.

In order to attach the screw driver end, the socket wrench attachment needs to be manually displaced in the vertical direction every time, namely against the force of the flat coil spring that is pushed onto the shaft in order to produce the non-positive connection between the socket wrench end and the screw driver end, and this not only represents a significant impairment during normal use, but also results in the socket wrench attachment always lying above the screw head when the tool is turned such that it is impossible to optically control the turning motion and the snug fit of the tool.

In view of the foregoing, at least one objective is to provide a combination tool that makes it possible to realize a combination of different functional fastening bits and can be used in a machine-bound fashion, namely while simultaneously improving the handling of the selected tool head. In addition, other objectives, desirable features and characteristics will become apparent from the subsequent summary and detailed description, and the appended claims, taken in conjunction with the accompanying drawings and this background.

### SUMMARY

According to and embodiment of the invention, this at least one objective, and other objectives, desirable features, and characteristics, is attained a combination tool comprising a tool shaft with an inner part and an outer part, a first tool head that is integrally formed on the inner part and a differently designed second tool head that is integrally formed on the outer part. The tool shaft is realized in such a way that it can be inserted into a machine and features at least one holding element for mounting a tool head thereon in a locking fashion.

This arrangement advantageously makes it possible to realize a combination of different functional tool head bits, as well as to significantly improve the locking of the tool heads due to its design. The machine-bound use of the combination tool is achieved in that the different tool heads are no longer manually selected. In addition, an optical control can be realized in the machine-bound mode due to the ability to lock the tool heads.

In the combination tool in accordance with an embodiment, the outside of the inner part and the inside of the outer part preferably are at least partially designed in such a way that a non-positive connection can be produced. For example, the transmission of the tool shaft torque from the inner part to the outer part can be ensured, for example, with a hexagonal connection that has a positive fit. This advantageous design makes it possible to realize a reliable and long-lasting torque transmission that only requires low manufacturing expenditures.

In another preferred embodiment of the invention, the first tool head may comprise a bit for torx screws. It is preferred that the second tool head alternatively or additionally comprises a bit for hexagon head screws. They may be realized cylindrically for a certain size or conically for a variable size of screws.

In another preferred embodiment of the invention, the outer part may laterally feature two oblong holes. The oblong holes in connection with a correspondingly arranged guide pin can be advantageously used as a guide for the horizontal displacement of the inner part relative to the outer part.

In another preferred embodiment of the invention, the holding element may be realized in the form of a pin mechanism with a spring. The spring may advantageously consist of a flat coil spring. It holds the inner part in its initial position while the pin secures and guides the inner part relative to the outer part.

### BRIEF DESCRIPTION OF THE DRAWINGS

The present invention will hereinafter be described in conjunction with the following drawing figures, wherein like numerals denote like elements, and:

FIG. 1 shows a perspective exploded view of an inventive combination tool.

### DETAILED DESCRIPTION

The following detailed description is merely exemplary in nature and is not intended to limit the application and uses. Furthermore, there is no intention to be bound by any theory presented in the preceding background and summary or the following detailed description.

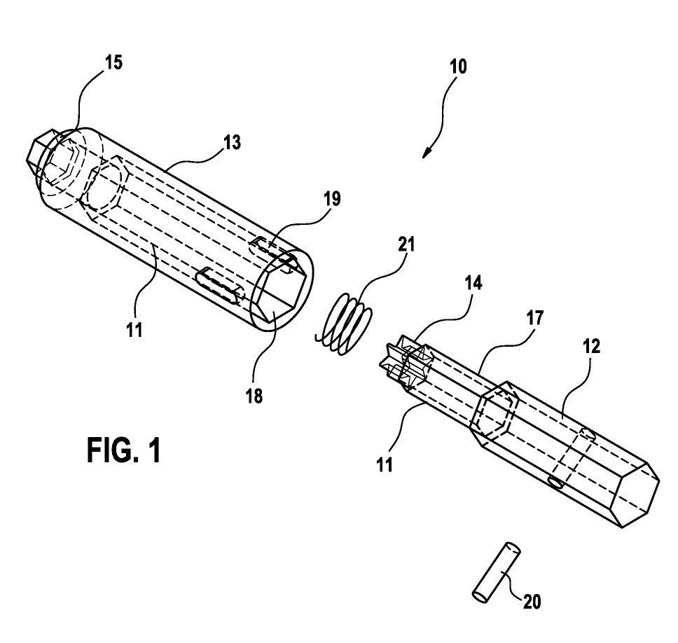

FIG. 1 shows an inventive combination tool 10 in the form of a perspective exploded view. The tool shaft 11 is formed by an outer part 13 and an inner part 12. The inner part 12 features a first tool head 14 in the form of a head for torx screws that is integrally formed on its end. The outer part 13, in contrast, features a second tool head 15 in the form of a hexagon wrench that is integrally formed on its end. In the shaft region, the outside 17 of the inner part 12 and the inside 18 of the outer part 13 are realized in such a way that they produce a non-positive connection. This ensures a long-lasting and reliable torque transmission. In the present combination tool, this is achieved with a partial, mutually adapted polygonal design of the respective sides 17 and 18. In the embodiment of the invention illustrated in the figure, the combination tool 10 also features a lockable holding element 16 in the form of a pin mechanism 20 with a spring 21. The pin can be inserted into a recess of the inner part. It can furthermore be horizontally displaced in one respective lateral oblong hole 19 of the outer part 13 such that the inner part 12 is additionally guided relative to the outer part 13.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A combination tool, comprising
a tool shaft with an inner part and an outer part;
a first tool head that is integrally formed on the inner part; and
a differently designed second tool head that is integrally formed on the outer part,
wherein the tool shaft is realized in such a way that it can be inserted into a machine and further comprises a holding element for mounting a tool head thereon in a locking fashion.

2. The combination tool according to claim 1, wherein the outside of the inner part and the inside of the outer part are at least partially realized to produce a non-positive connection.

3. The combination tool according to claim 1, wherein the first tool head comprises a bit for torx screws.

4. The combination tool according to claim 1, wherein the differently designed second tool head comprises a bit for hexagon head screws.

5. The combination tool according to claim 1, wherein the outer part comprises a plurality of oblong holes.

6. The combination tool according to claim 1, wherein the holding element comprises a pin mechanism with a spring.
